(19) United States
(12) Patent Application Publication
(10) Pub. No.: US 2016/0266598 A1
(43) Pub. Date: Sep. 15, 2016

(54) PRECISION BANDGAP REFERENCE

(71) Applicant: QUALCOMM Incorporated, San Diego, CA (US)

(72) Inventors: Mong Chit Wong, San Diego, CA (US); Nam Van Dang, San Diego, CA (US); Rajeev Jain, San Diego, CA (US); Bo-Ren Wang, San Diego, CA (US); Sassan Shahrokhinia, San Diego, CA (US)

(21) Appl. No.: 14/643,981

(22) Filed: Mar. 10, 2015

(51) Int. Cl. G05F 3/26

(52) U.S. Cl. CPC G05F 3/267

(57) ABSTRACT

Systems and methods for producing reference voltages are disclosed. An example bandgap reference circuit includes a core bandgap module that produces a bias control for biasing the gate of a transistor to produce a proportional to absolute temperature current. The core bandgap module may use an operational amplifier that uses auto-calibration to reduce its input offset voltage. A trimming module uses the bias control to produce a proportional to absolute temperature current that is combined with a trim current and supplied to a resistor and diode to produce a trimmed bandgap voltage. The trimmed bandgap voltage is buffered to produce a reference voltage output. The trim current may be set based on a room temperature measurement of the reference voltage output.

### BACKGROUND

1. Field

The present invention relates to electronic circuits and, more particularly, to precision bandgap reference circuits.

2. Background

A building block of many electronic circuits is a reference voltage that exhibits little dependence on supply voltage, little dependence on fabrication process conditions, and little dependence on temperature. Bandgap reference circuits are commonly used to provide reference voltages. The reference voltage output from a bandgap reference circuit can be used, for example, in an analog-to-digital converter to accurately quantify an input, in a digital-to-analog converter to define the output full-scale range, and in a power supply to accurately control a supplied voltage level.

Bandgap reference circuits create a temperature-stable reference voltage by adding a diode voltage, which has a negative temperature coefficient (also referred to as complementary to absolute temperature (CTAT)), to a voltage that is proportional to absolute temperature (PTAT) with the addition done in such a way that the temperature coefficient of the sum is nearly zero. Bandgap reference circuits generally include two diode-connected bipolar junction transistors (BJTs) operating at different emitter current densities, resistors for summing, and an operational amplifier providing amplified feedback to establish the desired operating point.

The ideal bandgap reference circuit produces a reference voltage that is constant regardless of process, voltage, and temperature variations. However, process variations (including mismatches between like circuit elements) can impact the value of the reference voltage. For example, an input offset voltage of the operational amplifier may vary considerably with process variations that occur in large-scale manufacture (e.g., millions of units) of integrated circuits. This input offset voltage is amplified and creates an error in the bandgap voltage. Variations in resistor values and transistor characteristics also cause errors in the bandgap voltage.

Implementing bandgap reference circuits in advanced process nodes is difficult. Characteristics of advanced process nodes that impair performance of bandgap reference circuits include greater process variation, limited choice of transistor sizes, and lower supply voltages. To reduce reference voltage variation, prior bandgap reference circuits use resistor DAC trimming, large ratios of bipolar transistor sizes and large resistor sizes, two series base-emitter bipolar transistors, and chopping to mitigate amplifier offsets. Each of these techniques has associated disadvantages (e.g., larger circuit area, increased power dissipation, increased noise on the reference voltage) and may still produce unsatisfactory results.

### SUMMARY

In one aspect, a bandgap reference circuit is provided. The bandgap reference circuit includes: a core bandgap module configured to produce a bias control for biasing a transistor to produce a proportional to absolute temperature current; a trimming module including a diode device, a transistor configured to supply a proportional to absolute temperature current based on the bias control, a resistor having a first terminal coupled to the transistor and a second terminal coup in a him and led to the diode device, and a trim digital-to-analog converter having an output coupled to the first terminal of the resistor, wherein the trim digital-to-analog converter is configured to source or sink an amount of current based on a trim control; and an output buffer configured to buffer the first terminal of the resistor to produce a reference voltage output.

In one aspect, another bandgap reference circuit is provided. The bandgap reference circuit includes: a core bandgap module configured to produce a bandgap voltage, wherein the core bandgap module includes an operational amplifier with auto-calibration operable to reduce an input offset voltage of the operational amplifier, wherein the operational amplifier includes a pair of variable strength transistors forming an input differential pair of the operational amplifier; and an output buffer configured to buffer the bandgap voltage from the core bandgap module to produce a reference voltage output.

In one aspect, a method for producing a reference voltage is provided. The method includes: generating a proportional to absolute temperature current; supplying the proportional to absolute temperature current to a resistor coupled in series with a diode device; generating a trim current; summing the trim current with the proportional to absolute temperature current to alter the current through the resistor and the diode device and to produce a trimmed bandgap voltage across the resistor and the diode device and produce a trimmed bandgap voltage; and buffering the trimmed bandgap voltage to produce the reference voltage.

In one aspect, an apparatus for producing a reference voltage is provided. The apparatus includes: a core bandgap means for producing a bias control for biasing a transistor to produce a proportional to absolute temperature current; a means for trimming including a diode device, a transistor configured to supply a proportional to absolute temperature current based on the bias control, a resistor having a first terminal coupled to the transistor and a second terminal coupled to the diode device, and a trim means for sourcing or sinking current to or from the first terminal of the resistor based on a trim control; and a buffer means for buffering the first terminal of the resistor to produce the reference voltage.

Other features and advantages of the present invention should be apparent from the following description which illustrates, by way of example, aspects of the invention.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a schematic diagram of a bandgap reference circuit according to a presently disclosed embodiment;

FIG. 2 is a schematic diagram of a trim digital-to-analog converter according to a presently disclosed embodiment;

FIG. 3 is a schematic diagram of an operational amplifier with auto-calibration according to a presently disclosed embodiment;

FIG. 4 is a schematic diagram of a variable strength transistor according to a presently disclosed embodiment;

FIG. 5 is a flowchart of a process for producing a reference voltage according to a presently disclosed embodiment.

### DETAILED DESCRIPTION

The detailed description set forth below, in connection with the accompanying drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in simplified form in order to avoid obscuring such concepts.

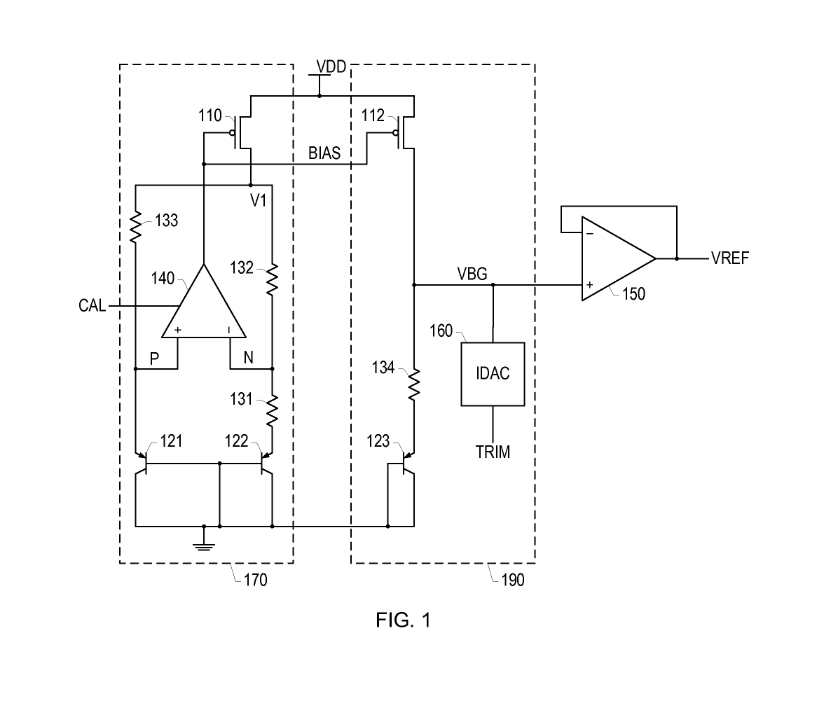

FIG. 1 is a schematic diagram of a bandgap reference circuit according to a presently disclosed embodiment. The bandgap reference circuit may be implemented, for example, in a complementary metal oxide semiconductor (CMOS) system-on-a-chip (SoC) integrated circuit (IC). The bandgap reference circuit is suitable for use in an advanced process node, for example, a 14 nm FinFET process. The bandgap reference circuit includes produces a reference voltage output VREF from a supply voltage VDD (e.g., 1.8 V).

The bandgap reference circuit includes a core bandgap module 170 that includes p-channel transistor 110 that sources current to node V1 (bandgap voltage). The current sourced by p-channel transistor 110 is supplied to the emitter terminal of diode-connected PNP BJT 121 via resistor 133 and to the emitter terminal of diode-connected PNP BJT 122 via resistor 132 and resistor 131. The base and collector terminals of BJT 121 and BJT 122 connect to a ground reference. BJT 121 and BJT 122 may be referred to as diode devices with the base and collector terminals collectively referred to as cathode terminals and the emitter terminals referred to as anode terminals. BJT 121 and BJT 122 may be implemented with other devices, for example, junction diodes. The bandgap reference circuit produces an output whose voltage is substantially independent (e.g., less than 1% change) of process, voltage, and temperature.

The core bandgap module 170 also includes an operational amplifier 140. The operational amplifier 140 may be, for example, an operational transconductance amplifier. The operational amplifier 140 has a non-inverting input connected to the emitter terminal of BJT 121 (node P) and an inverting input connected to the emitter terminal of BJT 122 (node N). The output (node BIAS) of the operational amplifier 140 connects to the gate of p-channel transistor 110 (whose drain connects to node V1 and whose source connects to a voltage supply VDD). The operational amplifier 140 operates to equate the voltages at node P and node N and generate a proportional-to-absolute-temperature (PTAT) current sourced by p-channel transistor 110. The values of the circuit elements (resistances of resistor 131, resistor 132, and resistor 133 and the size ratio of BJT 122 to BJT 122) can be chosen so that the voltage on node V1 is substantially independent of temperature. The voltage on node V1 may be referred to as a bandgap voltage.

Offset voltages at the input of the operational amplifier 140 cause errors in level of the output of the bandgap reference circuit. The input offset voltage is amplified by one plus the ratio of the resistance of resistor 132 to the resistance of resistor 131. This amplification is by a factor of about 10 for common resistance values. The operational amplifier 140 includes an auto-calibration function to reduce or eliminate the input offset voltage. Auto-calibration of the operational amplifier 140 reduces or eliminates the error in the output of the bandgap reference circuit voltage caused by the input offset voltage of operational amplifier 140.

The operational amplifier 140 performs auto-calibration when triggered by a calibration input CAL. The calibration input may, for example, cause the operational amplifier 140 to perform auto-calibration when the bandgap reference circuit powers up. Thereafter, the operational amplifier 140 operates as a conventional operational amplifier but with a reduced or eliminated input offset voltage.

The bandgap reference circuit includes a trimming module 190 to adjust the circuit for process variations. Process variations can, for example, cause the level of the output of the bandgap reference circuit to vary from a desired value. The trimming module 190 can adjust the level of the output of the bandgap reference circuit to the desired value or very close to the desired value. The trimming module 190 may be implemented without added integrated circuit package pins or components external to the integrated circuit.

The trimming module 190 includes p-channel transistor 112, resistor 134, BJT 123, and a trim digital-to-analog converter (DAC) 160. P-channel transistor 112 sources current to node VBG. The current sourced or sunk by trim DAC 160 trims the voltage on node VBG and may be referred to as a trim current. The voltage on node VBG may be similar to the voltage on node V1; however, node VBG is affected by trimming. Accordingly, the voltage on node VBG may be referred to as a trimmed bandgap voltage.

The current sourced by p-channel transistor 112 is supplied to the emitter terminal of diode-connected PNP BJT 123 via resistor 134. The base and collector terminals of BJT 123 connected to the ground reference. BJT 123 may also be referred to as a diode device. BJT 123 may be implemented with other devices, for example, a junction diode.

The gate of p-channel transistor 112 connects to the gate of p-channel transistor 110 (the output of operational amplifier 140) and the source of p-channel transistor 112 connects to the source of p-channel transistor 110 (the voltage supply VDD). Thus, the current sourced by p-channel transistor 112 is a mirror of the current sourced by p-channel transistor 110 and is also a PTAT current. The current sourced by p-channel transistor 112 may be a scaled version (e.g., scaled in proportion to the size of p-channel transistor 112 and the size of p-channel transistor 110) of the current sourced by p-channel transistor 110. The values of the circuit elements (resistance of resistor 134, size of p-channel transistor 112, size of BJT 123) can be chosen so that the voltage on node VBG is substantially independent of temperature (e.g., by choosing values so that temperature-induced changes in the PTAT voltage across resistor 134 offset temperature-induced changes in the CTAT voltage across BJT 123). The voltage on node VBG, in an embodiment, is nominally (with zero trim current and perfectly matched components) equal to the voltage on node V1.

The trim DAC 160 can source current to node VBG or sink current from node VBG. The trim current from trim DAC 160 is summed with the PTAT current from p-channel transistor 112 by the common connection of trim DAC 160 and p-channel transistor 112 to node VBG. Accordingly, changes in the trim current change the current in resistor 134 and diode-connected PNP BJT 123. The current summing allows the trim current, for example, to compensate for mismatches in the current mirroring from p-channel transistor 110 to p-channel transistor 112.

When the trim DAC 160 sources current, the current through resistor 134 and BJT 123 increases thereby increasing the voltage at node VBG; when the trim DAC 160 sinks current, the current through resistor 134 and BJT 123 decreases thereby decreasing the voltage at node VBG. Whether the trim DAC 160 sources or sinks current and the magnitude of the current (which may be zero) is controlled by a trim control TRIM. The trim control, in the illustrated embodiment, is a digital trim control. In an example embodiment, the minimum adjustment of the trim DAC 160 changes the output of the bandgap reference circuit approximately 2 mV and the maximum adjustment of the trim DAC 160 changes the output of the bandgap reference circuit approximately 125 mV.

The value of the trim control may be determined using a single-condition measurement of the bandgap reference circuit, for example, a measurement of the output voltage at room temperature. (e.g., 20° C.) Although a single trim adjustment is used, the adjustment can compensate for variations in many circuit elements. The measurement may be performed during manufacturing of an integrated circuit containing the bandgap reference circuit with the corresponding trim value stored in the integrated circuit. The output of the bandgap reference circuit may be supplied for measurement external to the integrated circuit using an analog test bus.

The bandgap reference circuit includes an output buffer 150. The output buffer 150 produces the output VREF of the bandgap reference circuit by buffering node VBG from the trimming module 190. The output buffer 150 may, as illustrated in FIG. 1 be implemented with an operational amplifier connected in a unity-gain configuration (non-inverting input connected to node VBG and inverting input connected to output VREF). In other embodiments, the output buffer may have a gain of unity. Based on his function, the output of the bandgap reference circuit may also be referred to as a reference voltage output.

The bandgap reference circuit may include additional circuitry and features. For example, the core bandgap module 170 may include a startup circuit to assure that the bandgap reference circuit does not operate at an undesired stable operating point. The bandgap reference circuit may also include power-down or standby functions. Additionally, components may be added between the described elements. For example, elements may be added in a current path (e.g., for a power-down function) without otherwise modifying operation of the circuit. In an embodiment, however, p-channel transistor 112, resistor 134, and diode-connected PNP BJT are coupled in series without intervening components.

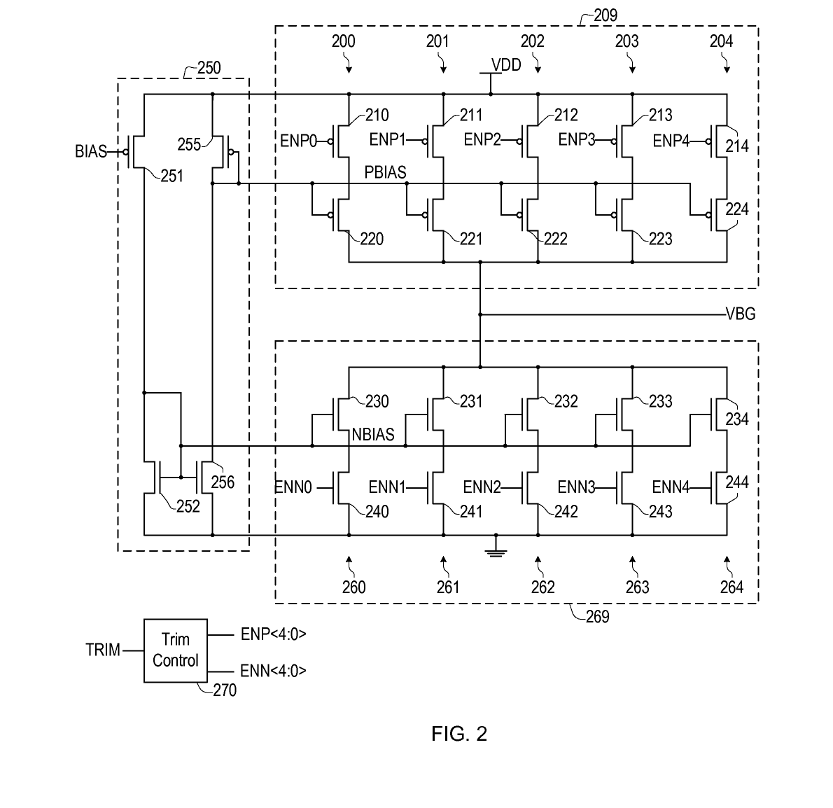

FIG. 2 is a schematic diagram of a trim digital-to-analog converter according to a presently disclosed embodiment. The trim DAC may, for example, implement the trim DAC 160 of the bandgap reference circuit of FIG. 1.

The trim DAC receives a trim control TRIM and sources a current to or sinks a current from an output VBG based on the value signaled by the trim control. When used in the bandgap reference circuit of FIG. 1, the output VBG connects to node VBG of FIG. 1. The trim DAC receives a bias input BIAS that biases the magnitudes of the currents sourced or sunk by the trim DAC. When used in the bandgap reference circuit of FIG. 1, the bias input may be connected to the output of operational amplifier 140 (node BIAS). This allows the trimming currents to be in proportion to the PTAT currents of the bandgap reference circuit. The proportionality may reduce temperature-induced variation in the bandgap reference circuit output voltage. Other biasing methods (e.g., those not using a PTAT current) may also be used.

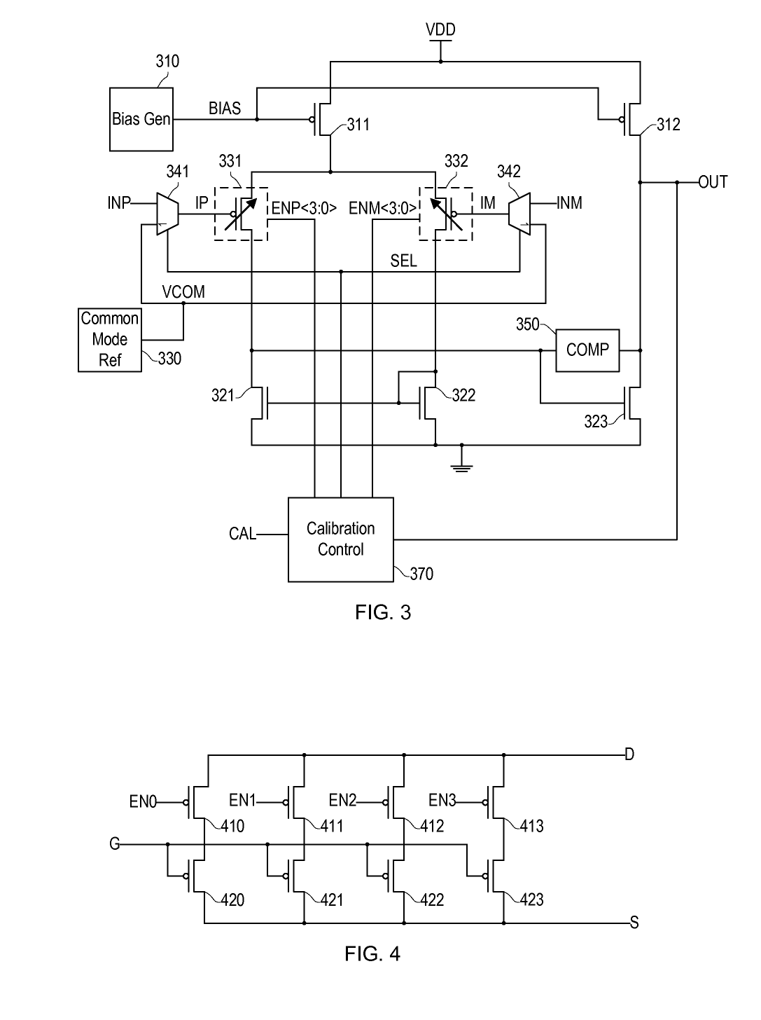

The trim DAC includes a bias module 250, a current source module 209, a current sink module 269, and a trim control module 270. The bias module 250 supplies a source bias control (node PBIAS) to the current source module 209 and a sink bias control (node NBIAS) to the current sink module 269. The current source module 209 sources current to the output VBG and the current sink module 269 sinks current from the output VBG. The amounts of current sourced and sunk are controlled digitally by control signals from the trim control module 270. In the embodiment illustrated in FIG. 3, the current source module 209 and the current sink module 269 source or sink current to and from the same node.

The bias module 250 includes p-channel transistor 251, n-channel transistor 252, n-channel transistor 256, and p-channel transistor 255. The gate of p-channel transistor 251 connects to the bias input, the source of p-channel transistor 251 connects to a voltage supply VDD, and the drain of p-channel transistor 251 sources current to the drain of n-channel transistor 252. The gate and drain of n-channel transistor 252 connect to the drain of p-channel transistor 251 and the source of n-channel transistor 252 connects to a ground reference. The gate of n-channel transistor 256 connects to the gate of n-channel transistor 252, the source of n-channel transistor 256 connects to the ground reference, and the drain of n-channel transistor 256 sinks a current from p-channel transistor 255. The gate and drain of p-channel transistor 255 connect to the drain of n-channel transistor 256 and the source of p-channel transistor 255 connects to the voltage supply.

The current sourced by p-channel transistor 251 is controlled by the bias input. Diode-connected n-channel transistor 252 establishes a bias voltage on the sink bias control NBIAS for the current sink module 269 based on the current sourced by p-channel transistor 251. Thus, the bias voltage for the current sink module 269 is also controlled by the bias input. N-channel transistor 252 and n-channel transistor 256 form a current mirror. The current sunk by n-channel transistor 256 is also based on the bias input by operation of the current mirror. Diode-connected p-channel transistor 255 establishes a bias voltage on the source bias control PBIAS for the current source module 209 based on the current sunk by n-channel transistor 256. Thus, the bias voltage for the current source module 209 is also controlled by the bias input.

The current source module 209 includes five enableable current sources 200-204. The currents sourced by the enableable current sources 200-204 may be binary weighted with the current of the fifth enableable current source 204 being twice as large as the current of the fourth enableable current source 203, which is twice as large as the current of the third enableable current source 202, which is twice as large as the current of the second enableable current source 201, which is twice as large as the current of the first enableable current source 200. Each of the enableable current sources includes two p-channel transistors connected in series between the voltage supply and the output of the trim DAC. First ones of the series p-channel transistors (210-214) are switched on or off by source controls ENP<4:0> from the trim control module 270. Second ones of the series p-channel transistors (220-224) are biased by the source bias control. The p-channel transistors of the enableable current sources may be sized in proportion to the associated currents.

The current sink module 269 includes five enableable current sinks 260-264. The currents sunk by the enableable current sinks 260-264 may be binary weighted with the current of the fifth enableable current sink 264 being twice as large as the current of the fourth enableable current sink 263, which is twice as large as the current of the third enableable current sink 262, which is twice as large as the current of the second enableable current sink 261, which is twice as large as the current of the first enableable current sink 260. Each of the enableable current sinks includes two n-channel transistors connected in series between the ground reference and the output of the trim DAC. First ones of the series n-channel transistors 240-244 are switched on or off by sink controls ENN<4:0> from the trim control module 270. Second ones of the series n-channel transistors (230-234) are biased by the sink bias control. The n-channel transistors of the enableable current sources may be sized in proportion to the associated currents.

The sizes of the biasing transistors (p-channel transistor 251, n-channel transistor 252, n-channel transistor 256, and p-channel transistor 255), current source transistors (p-channel transistors 220-224), and current sink transistors (n-channel transistors 240-244) can be chosen to provide a desired trim range and resolution. In an example implementation of the bandgap reference circuit, the least-significant current is approximately one-hundredth the current sourced by p-channel transistor 112.

The trim control module 270 decodes the trim control TRIM to produce source controls ENP<4:0> for the current sourcing portion of the trim DAC and sink controls ENN<4:0> for the current sinking portion of the trim DAC. The decoding performed by the trim control module 270 may vary depending upon how the trim control is coded and how the current source module 209 and the current sink module 269 are controlled.

In the embodiment of FIG. 2, for example, the trim control may be a twos-complement value and the source controls are active low and binary weighted and the sink controls are active high and binary weighted. The trim control module 270 may then produce the controls by comparing the trim control to zero. The trim control module 270 can then, when the trim control is greater than zero, produce the source controls as the ones-complement of the trim control and, when the trim control is not greater than zero, produce the source controls as ONES to disable the enableable current sources. Similarly, the trim control module 270 can, when the trim control is less than zero, produce the sink controls as the twos-complement of the trim control and, when the trim control is not less than zero, produce the sink controls as ZEROS to disable the enableable current sinks

FIG. 3 is a schematic diagram of an operational amplifier with auto-calibration according to a presently disclosed embodiment. The operational amplifier with auto-calibration may, for example, implement the operational amplifier 140 of the bandgap reference circuit of FIG. 1. The operational amplifier may also be used in other circuits, for example, circuits that would benefit from a reduced input offset voltage. The operational amplifier has the general structure of a two-stage Miller operational transconductance amplifier. However, the operational amplifier of FIG. 3 includes variable strength transistors in the differential pair of the input stage.

The operational amplifier receives a non-inverting input INP and an inverting input INM and produces an output OUT based, during normal (non-calibration) operation, on the voltage between the non-inverting input and the inverting input. The operational amplifier also receives a calibration input CAL to trigger auto-calibration of the operational amplifier. When used in the bandgap reference circuit of FIG. 1, the non-inverting input INP may be connected to node P, the inverting input INM may be connected to node N, the calibration input CAL connected to the calibration input CAL, and the output OUT connected to node BIAS.

The first stage of the operational amplifier includes a differential pair implemented with variable strength transistors 331, 332 and active loads implemented with n-channel transistors 321, 322. Current to the differential pair is supplied by p-channel transistor 311. As illustrated in FIG. 3, p-channel transistor 311 has a source connected to a voltage supply VDD, a gate connected to a bias signal BIAS, and a drain connected to a common node of the differential pair. A bias generation module 310 supplies the bias signal. The bias generation module 310 may use, for example, a combination of a resistor and diode-connected transistors to produce the bias signal. N-channel transistor 321 has a gate connected to the gate of n-channel transistor 322, a source connected to a ground reference, and a drain connected to the drain of variable strength transistor 331 and to the output of the first stage. N-channel transistor 322 has a source connected to the ground reference and a gate and a drain commonly connected to the drain of variable strength transistor 332.

The variable strength transistors 331, 332 function as p-channel transistors with gate terminals connected to the inputs, source terminals connected in common to p-channel transistor 311 and drain terminals connected to the active loads. However, the strength of the variable strength transistors 331, 332 are adjustable and controlled by strength controls ENP<3:0>, ENM<3:0>. The strength controls may be viewed as controlling the widths of the variable strength transistors. In the embodiment illustrated in FIG. 3, the strength controls are 4-bits wide and control the strengths of the variable strength transistors over a relative range of 0 to 15.

The second stage of the operational amplifier includes n-channel transistor 323 arranged as a common-source amplifier and p-channel transistor 312 arranged as a current source load. As illustrated in FIG. 3, p-channel transistor 312 has a gate connected to the bias signal, a source connected to the voltage supply, and a drain connected to the output of the operational amplifier. N-channel transistor 323 has a gate connected to the output of the first stage, a source connected to the ground reference, and a drain connected to the output of the operational amplifier. A compensation module 350 connects between the drain and the gate of n-channel transistor 323 to assure stability of the operational amplifier. The compensation module 350 may include, for example, a series resistor and capacitor.

A calibration control module 370 controls auto-calibration of the operational amplifier when triggered by the calibration input CAL. The calibration control module 370 controls the inputs to the differential pair of the operational amplifier by controlling selectors 341, 342. During auto-calibration, the inputs of the differential pair are supplied with a common mode voltage VCOM. A common mode reference module 330 supplies the common mode voltage. The common mode reference module 330 may use, for example, diode-connected p-channel and n-channel transistors coupled in series between the voltage supply and the ground reference to produce the common mode voltage. The voltage level of the common mode voltage may, for example, be approximately equal to the operating levels of the inputs of the operational amplifier 140 in the bandgap reference circuit of FIG. 1. During normal operation, the inputs of the differential pair are supplied with the inputs of the operational amplifier.

During auto-calibration, the inputs to the differential pair are at the same level and the output of the operational amplifier should be at a midpoint. However, due to mismatches between the variable strength transistors 331, 332 or the active loads (n-channel transistors 321, 322) there will be an input offset voltage, which the operational amplifier will amplify to the output. The calibration control module 370 adjusts the strengths of the variable strength transistors 331, 332 to reduce or eliminate the input offset voltage.

The calibration control module 370 may perform auto-calibration by initially setting the strength controls so that the positive side (variable strength transistor 331) is at a maximum strength and the minus side (variable strength transistor 332) is at a minimum strength. This causes the operational amplifier output to be at a low level. The calibration control module 370 may increment the strength of the minus side to its maximum in then, if necessary, decrement the strength of the positive side until the output switches to a high level. The settings of the strength controls are then used during normal operation of the operational amplifier. The calibration control module 370 may use a clock input to time the various steps of auto-calibration. Other techniques to determine the strength settings may also be used, for example, a binary search.

In an example embodiment, the auto-calibration is performed in about 10 μs (using a 4.8 MHz clock). Power dissipation of the operational amplifier is increased by approximately 200 μW during auto-calibration; however, after auto-calibration, the additional power is insignificant (e.g., leakage currents in the calibration control module 370). The input offset voltage of the operational amplifier after auto-calibration is less than 0.7 mV. The operational amplifier of FIG. 3 does not use any production trimming, added integrated circuit package pins, or components external to the integrated circuit.

FIG. 4 is a schematic diagram of a variable strength transistor according to a presently disclosed embodiment. The variable strength transistor may, for example, implement the variable strength transistors 331, 332 of the operational amplifier with auto-calibration of FIG. 3.

The strength of the variable strength transistor is controlled by enabling or disabling series-connected transistor pairs. The series-connected transistor pairs are coupled in parallel. Each series-connected transistor pair includes a first transistor whose gate connects to a gate input G (e.g., the inverting or non-inverting input of the operational amplifier) and a second transistor whose gate connects to a strength control. The variable strength transistor, in the embodiment of FIG. 4, includes four binary-weighted p-channel transistors 420-423. The p-channel transistors 420-423 are connected in series with four enable p-channel transistors 410-413. The binary-weighting may be provided by designing p-channel transistor 423 to be twice as large as p-channel transistor 422, which is twice as large as p-channel transistor 421, which is twice as large as p-channel transistor 420. In an embodiment, the variable strength transistor includes an always enabled transistor pair (e.g., the second transistor shorted or always on).

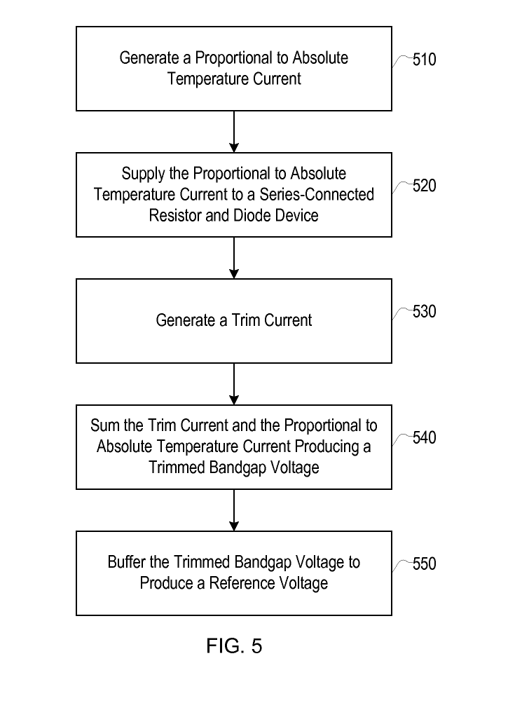

FIG. 5 is a flowchart of a process for producing a reference voltage according to a presently disclosed embodiment. The process will be described with reference to the bandgap reference circuit of FIG. 1; however, various embodiments of the process may be applied to any suitable apparatus.

In block 510, the core bandgap module 170 biases p-channel transistor 112 to produce a PTAT current. Accordingly, producing the PTAT current may include auto-calibrating an operational amplifier to reduce an input offset voltage of the operational amplifier.

In block 520, the PTAT current from p-channel transistor 112 is supplied to resistor 134 and diode-connected PNP BJT 123. Since resistor 134 and BJT 123 are connected in series, the voltage across the resistor 134 and BJT 123 is the sum of the voltage across resistor 134 (which is PTAT) and BJT 123 (which is CTAT).

In block 530, the trim DAC 160 produces a trim current. The trim current is controlled by the trim control and may be positive or negative. The trim control may be set based on a single-condition measurement of the reference voltage. The trim control may be further based on the PTAT current.

In block 540, the PTAT current and the trim current are summed by the connection of the p-channel transistor 112 to the output of the trim DAC 160. The summed current is supplied to resistor 134 and BJT 123 to produce a trimmed bandgap voltage between node VBG and the ground reference (across resistor 134 and BJT 123). The trim current alters the current through both resistor 134 and BJT 123. Since the trim current may be positive or negative, the trim current may increase or decrease the trimmed bandgap voltage.

In block 550, the output buffer 150 buffers the trimmed bandgap voltage to produce the reference voltage.

The process of FIG. 5 may be modified, for example, by adding or altering steps. Additionally, steps may be performed concurrently.

The presently disclosed systems and methods provide precision bandgap references in advanced process nodes, for example, a 14 nm FinFET process. The disclosed bandgap reference circuits can provide, for example, 1.25 V with less than 1% reference voltage variation over process, voltage, and temperature (−40° C. to 125° C.). Additionally, the disclosed bandgap reference circuits occupy a small integrated circuit area (e.g., 5000 μm2), dissipates low power (e.g., 900 μW), and can be used without added integrated circuit package pins or components external to the integrated circuit.

The disclosed bandgap reference circuits provide several advantages over prior bandgap reference circuits. For example, some prior circuits have used a larger BJT size ratio, which causes larger circuit layout area and thus greater manufacturing cost. Prior circuits have used resistor trimming which also causes larger circuit layout area. Prior circuits have used chopper amplifiers, which causes more noise and more power. Prior circuits have used additional integrated circuit package pins, which increases size and cost. Prior circuits have used larger sizes in the operational amplifier to improve matching and reduce input offset voltage. This also causes larger circuit layout area.

Although features of the invention are described above for particular embodiments, many variations are possible. For example, bandgap reference circuits may be formed using other fabrication processes including processes with different types of transistors. Further, bandgap reference circuits may have different bit widths for the trim and calibration controls. In another variation, the trimming module 190 may be removed or use a trim control having a fixed value. Similarly, an operational amplifier without auto-calibration or with a different auto-calibration may be used. Additionally, the order of series circuit elements may be altered. Additionally, features of the various embodiments may be combined in combinations that differ from those described above.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent presently preferred embodiments of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A bandgap reference circuit, comprising:
a core bandgap module configured to produce a bias control for producing a proportional to absolute temperature current;
a trimming module including
a diode device,
a transistor configured to supply a proportional to absolute temperature current based on the bias control,
a resistor having a first terminal coupled to the transistor and a second terminal coupled to the diode device, and
a trim digital-to-analog converter having an output coupled to the first terminal of the resistor, wherein the trim digital-to-analog converter is configured to source or sink an amount of current based on a trim control; and
an output buffer configured to buffer the first terminal of the resistor to produce a reference voltage output.

2. The bandgap reference circuit of claim 1, wherein the core bandgap module includes an operational amplifier with auto-calibration operable to reduce an input offset voltage of the operational amplifier, wherein an output of the operational amplifier connects to the bias control.

3. The bandgap reference circuit of claim 2, wherein the operational amplifier includes a pair of variable strength transistors forming an input differential pair of the operational amplifier, each of the variable strength transistors including a plurality of series-connected transistor pairs, wherein each series-connected transistor pair includes a first transistor having a gate coupled to an input of the operational amplifier and a second transistor having a gate coupled to one of a plurality of strength controls.

4. The bandgap reference circuit of claim 3, wherein the operational amplifier further includes a calibration control module configured to auto-calibrate the operational amplifier by coupling the inputs of the operational amplifier to a common mode voltage and determining values for the plurality of strength controls coupled to the variable strength transistors to reduce the input offset voltage of the operational amplifier.

5. The bandgap reference circuit of claim 2, wherein the core bandgap module further includes:
a first diode device having a cathode terminal coupled to a ground reference and an anode terminal coupled to a first input of the operational amplifier;
a second diode device having a cathode terminal coupled to the ground reference;
a transistor having a gate terminal coupled to the bias control and a source terminal coupled to a voltage supply;
a first resistor having a first terminal coupled to a drain terminal of the transistor and a second terminal coupled to a first input of the operational amplifier;
a second resistor having a first terminal coupled to the drain terminal of the transistor and a second terminal coupled to a second input of the operational amplifier; and
a third resistor having a first terminal coupled to the second terminal of the second resistor and a second terminal coupled to an anode terminal of the second diode device.

6. The bandgap reference circuit of claim 1, wherein the trim digital-to-analog converter comprises:
a plurality of enableable current sources coupled to the output of the trim digital-to-analog converter; and
a plurality of enableable current sinks coupled to the output of the trim digital-to-analog converter.

7. The bandgap reference circuit of claim 6, wherein each of the plurality of enableable current sources includes a first p-channel transistor and a second p-channel transistor coupled in series between a voltage supply and the output of the trim digital-to-analog converter, wherein the first p-channel transistor has a gate terminal coupled to a source control and the second p-channel transistor has a gate terminal coupled to a source bias control, and
wherein each of the plurality of enableable current sinks includes a first n-channel transistor and a second n-channel transistor coupled in series between a ground reference and the output of the trim digital-to-analog converter, wherein the first n-channel transistor has a gate terminal coupled to a sink control and the second n-channel transistor has a gate terminal coupled to a sink bias control.

8. The bandgap reference circuit of claim 7, wherein the trim digital-to-analog converter further comprises a bias module configured to produce the source bias control and the sink bias control based on the bias control produced by the core bandgap module.

9. The bandgap reference circuit of claim 1, wherein the amount of current sourced or sunk by the trim digital-to-analog converter is further based on the bias control produced by the core bandgap module.

10. The bandgap reference circuit of claim 1, wherein the diode device is a diode-connected bipolar junction transistor.

11. A bandgap reference circuit, comprising:
a core bandgap module configured to produce a bandgap voltage, wherein the core bandgap module includes an operational amplifier with auto-calibration operable to reduce an input offset voltage of the operational amplifier, wherein the operational amplifier includes a pair of variable strength transistors forming an input differential pair of the operational amplifier; and
an output buffer configured to buffer the bandgap voltage from the core bandgap module to produce a reference voltage output.

12. The bandgap reference circuit of claim 11, wherein each of the variable strength transistors comprises a plurality of series-connected transistor pairs, wherein each series-connected transistor pair includes a first transistor having a gate coupled to an input of the operational amplifier and a second transistor having a gate coupled to one of a plurality of strength controls.

13. The bandgap reference circuit of claim 12, further comprising a calibration control module configured to auto-calibrate the operational amplifier by coupling the inputs of the operational amplifier to a common mode voltage and determining values for the plurality of strength controls coupled to the variable strength transistors to reduce the input offset voltage of the operational amplifier.

14. The bandgap reference circuit of claim 11, wherein the core bandgap module further includes
a first diode device having a cathode terminal coupled to a ground reference and an anode terminal coupled to a first input of the operational amplifier;
a second diode device having a cathode terminal coupled to the ground reference;
a transistor having a gate terminal coupled to the output of the operational amplifier and a source terminal coupled to a voltage supply;
a first resistor having a first terminal coupled to a drain terminal of the transistor and a second terminal coupled to a first input of the operational amplifier;
a second resistor having a first terminal coupled to the drain terminal of the transistor and a second terminal coupled to a second input of the operational amplifier; and
a third resistor having a first terminal coupled to the second terminal of the second resistor and a second terminal coupled to an anode terminal of the second diode device.

15. A method for producing a reference voltage, the method comprising:
generating a proportional to absolute temperature current;
supplying the proportional to absolute temperature current to a resistor coupled in series with a diode device;
generating a trim current;
summing the trim current with the proportional to absolute temperature current to alter the current through the resistor and the diode device and to produce a trimmed bandgap voltage across the resistor and the diode device; and
buffering the trimmed bandgap voltage to produce the reference voltage.

16. The method of claim 15, wherein the trim current is based on a digital trim control and the proportional to absolute temperature current.

17. The method of claim 15, wherein generating the proportional to absolute temperature current includes auto-calibrating an operational amplifier to reduce an input offset voltage of the operational amplifier.

18. The method of claim 17, wherein the operational amplifier includes a pair of variable strength transistors forming an input differential pair of the operational amplifier, each of the variable strength transistors including a plurality of series-connected transistor pairs, wherein each series-connected transistor pair includes a first transistor having a gate coupled to an input of the operational amplifier and a second transistor having a gate coupled to one of a plurality of strength controls.

19. The method of claim 18, wherein the operational amplifier further includes a calibration control module configured to auto-calibrate the operational amplifier by coupling the inputs of the operational amplifier to a common mode voltage and determining values for the plurality of strength controls coupled to the variable strength transistors to reduce the input offset voltage of the operational amplifier.

20. The method of claim 15, wherein the trim current is set based on a measurement of the reference voltage at room temperature.

21. An apparatus for producing a reference voltage, the apparatus comprising:
a core bandgap means for producing a bias control for producing a proportional to absolute temperature current;
a means for trimming including
a diode device,
a transistor configured to supply a proportional to absolute temperature current based on the bias control,
a resistor having a first terminal coupled to the transistor and a second terminal coupled to the diode device, and
a trim means for sourcing or sinking current to or from the first terminal of the resistor based on a trim control; and
a buffer means for buffering the first terminal of the resistor to produce the reference voltage.

22. The apparatus of claim 21, wherein the core bandgap means includes an operational amplifier with auto-calibration operable to reduce an input offset voltage of the operational amplifier, wherein an output of the operational amplifier connects to the bias control.

23. The apparatus of claim 22, wherein the operational amplifier includes a pair of variable strength transistors forming an input differential pair of the operational amplifier, each of the variable strength transistors including a plurality of series-connected transistor pairs, wherein each series-connected transistor pair includes a first transistor having a gate coupled to an input of the operational amplifier and a second transistor having a gate coupled to one of a plurality of strength controls.

24. The apparatus of claim 23, wherein the operational amplifier further includes a calibration control means for auto-calibrating the operational amplifier by coupling the inputs of the operational amplifier to a common mode voltage and determining values for the plurality of strength controls coupled to the variable strength transistors to reduce the input offset voltage of the operational amplifier.

25. The apparatus of claim 22, wherein the core bandgap means further includes:
a first diode device having a cathode terminal coupled to a ground reference and an anode terminal coupled to a first input of the operational amplifier;
a second diode device having a cathode terminal coupled to the ground reference;
a transistor having a gate terminal coupled to the bias control and a source terminal coupled to a voltage supply;
a first resistor having a first terminal coupled to a drain terminal of the transistor and a second terminal coupled to a first input of the operational amplifier;
a second resistor having a first terminal coupled to the drain terminal of the transistor and a second terminal coupled to a second input of the operational amplifier; and
a third resistor having a first terminal coupled to the second terminal of the second resistor and a second terminal coupled to an anode terminal of the second diode device.

26. The apparatus of claim 21, wherein the trim means comprises:
a plurality of enableable current sources coupled to an output of the trim means; and
a plurality of enableable current sinks coupled to the output of the trim means.

27. The apparatus of claim 26, wherein each of the plurality of enableable current sources includes a first p-channel transistor and a second p-channel transistor coupled in series between a voltage supply and the output of the trim means, wherein the first p-channel transistor has a gate terminal coupled to a source control and the second p-channel transistor has a gate terminal coupled to a source bias control, and
wherein each of the plurality of enableable current sinks includes a first n-channel transistor and a second n-channel transistor coupled in series between a ground reference and the output of the trim means, wherein the first n-channel transistor has a gate terminal coupled to a sink control and the second n-channel transistor has a gate terminal coupled to a sink bias control.

28. The apparatus of claim 27, wherein the trim means further comprises a bias module configured to produce the source bias control and the sink bias control based on the bias control produced by the core bandgap means.

29. The apparatus of claim 21, wherein the current sourced or sunk by the trim means is further based on the bias control produced by the core bandgap means.

30. The apparatus of claim 21, wherein the diode device is a diode-connected bipolar junction transistor.
